(19) United States
(12) Patent Application Publication
(10) Pub. No.: US 2023/0135103 A1
(43) Pub. Date: May 4, 2023

(54) LEADING WIRE OF RELEASE WHEEL OF PULL CORD IN A WINDOW BLIND

(71) Applicants: Hsien-Te HUANG, Taipei City (TW); Yu-Wei HUANG, Taipei City (TW)

(72) Inventors: Hsien-Te HUANG, Taipei City (TW); Yu-Wei HUANG, Taipei City (TW)

(21) Appl. No.: 17/556,073

(22) Filed: Dec. 20, 2021

(30) Foreign Application Priority Data
Nov. 3, 2021 (TW) 110212917

(51) Int. Cl. E06B 9/322

(52) U.S. Cl. CPC E06B 9/322; E06B 2009/3225

(57) ABSTRACT

A leading wire of pull cord of release wheel in a window blind is disclosed. In the beginning that the release wheel reels the pull cord, the winding angle of the pull cord can be defined that the wound reel can be neatly ordered. In a location of winding hub of the release wheel close to an inner spoke side, at least a piercing hole is transfixed along an inscribed tangent. In addition, a winding definer is further disposed in the direction at which the pull cord is spinning out, allowing the direction of an initial reeling coil to be defined in advance, so that the reel can be wound orderly.

### BACKGROUND OF THE INVENTION

### a) Field of the Invention

The present invention relates to a leading wire of release wheel of pull cord in a window blind, which provides for the release wheel to define a winding angle to the pull cord in the beginning of winding the pull cord, so that the wound reel can be neatly ordered.

### b) Description of the Prior Art

A window blind set 100 (as shown in FIG. 1) includes a top rail 71, and a bottom rail 72 disposed below and opposite to the top rail 71. Slats 74 are connected between the top rail 71 and the bottom rail 72, and a pull cord 11 is collected into a releasing unit 80 inside the top rail 71 after changing direction through a turning element 73. The pull cord 11 is also operated by the power from the releasing unit 80, and is collected and released to open and close the slats 74.

As shown in FIG. 1-1, the releasing unit 80 is formed by an upper frame plate 81 and a lower frame plate 82. A power switch wheel 83 and a pick-up wheel 84 are disposed between the upper frame plate 81 and the lower frame plate 82. The power switch wheel 83 and the pick-up wheel 84 achieve feedback power through elasticity of a constant-pressure coil spring 85, transmitting reaction to a release wheel 900 on each side thereof to reel the pull cord 11. Energy from the release wheel 900 on each side connects the pull cord 11, and links with the power switch wheel 83 and the pick-up wheel 84 to gnaw.

Referring to FIG. 2, the release wheel 900 is provided with a tread 301, and an end of the tread 301 is coaxially combined with a spoke 302. A coaxial gear 303 with linking power is disposed on the tread 301 of the release wheel 900, and is opened inward with an entanglement hole 304 in an inscribable manner to position a thread end of the pull cord 11 in a hollow space of the wheel body, allowing the thread end to be fastened and fixed reversely. As the inner diameter of the entanglement hole 304 must be enlarged so that the pull cord 11 can pass through the entanglement hole 304 easily, a lower tangent point of the pull cord 11 is close to a lower tangent point of the entanglement hole 304 upon implementation. Therefore, a gap G will be formed between a side of the thread of the pull cord 11 and an inner surface of the spoke 302. Due to the existence of the gap G, the reeling of a coil 102 of the pull cord 11 will be out of order, especially that there is a very large chance that a first coil 101 will enter into the gap G, which allows the subsequent winding to lose a precession angle that the winding is disorder. After winding by multiple turns, the order of winding is entangled, so that the pull cord 11 moves in non-uniform speed on the segment unit of slat 74 (as shown in FIG. 1) or a speed difference is formed between the pull cord 11 on two sides to lose the levelness of the bottom rail 72.

### SUMMARY OF THE INVENTION

The primary object of the present invention is to disclose a leading wire of release wheel of pull cord in a window blind. The leading wire provides for a window blind set with elastic feedback power for collecting, so that in the beginning that a provided spring motor acts on the release wheel of pull cord to reel the pull cord, the winding direction of the pull cord can be defined, allowing the wound reel to be neatly ordered. In addition, an intersected ring edge between a winding hub and an inner spoke side of the release wheel is provided with a winding definer, so that the direction of an initial reeling coil of winding can be defined in advance, thereby making the reel to be neatly ordered.

A second object of the present invention is to disclose a leading wire of release wheel of pull cord in a window blind, wherein a piercing hole penetrates two openings front-to-back along an inscribed tangent of winding hub, forming a pass in the middle.

A third object of the present invention is to disclose a leading wire of release wheel of pull cord in a window blind, wherein the exit of the piercing hole is oppositely connected with a helicoid slope of helicoid dike provided by a winding definer.

A fourth object of the present invention is to disclose a leading wire of release wheel of pull cord in a window blind. The maximum radial height of the winding definer is equal to or smaller than the line width of the pull cord, and the axial width of the winding definer is equal to or smaller than the line width of the pull cord.

A fifth object of the present invention is to disclose a leading wire of release wheel of pull cord in a window blind, wherein the winding definer and the release wheel are formed integrally with a plastic material.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a front view of a conventional window blind set.

FIG. 1-1 shows a structural diagram of a power unit in the window blind set.

FIG. 2 shows a schematic view of operation of a conventional release wheel.

FIG. 3 shows a three-dimensional view of an infrastructure of release wheel, according to the present invention.

FIG. 4 shows a side structural view of the release wheel having a piercing hole, according to the present invention.

FIG. 5 shows a three-dimensional structural view of the release wheel having a winding definer, according to the present invention.

FIG. 6 shows a side structural view of the release wheel having the winding definer, according to the present invention.

FIG. 7 shows a front view of the present invention, which is transfixed with a pull cord.

FIG. 8 shows a schematic view of a gesture in which the winding definer provides for winding the pull cord, according to the present invention.

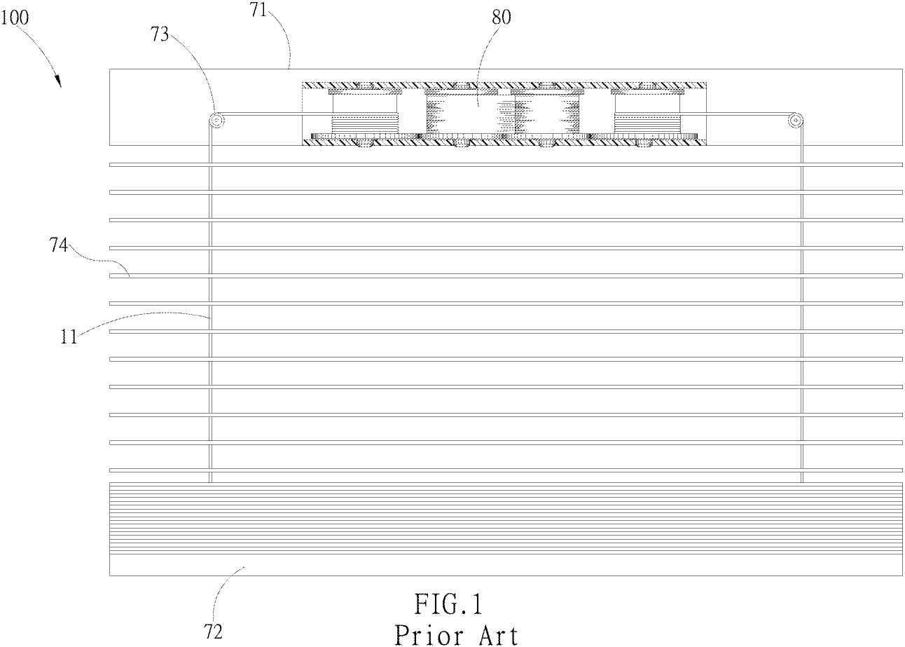

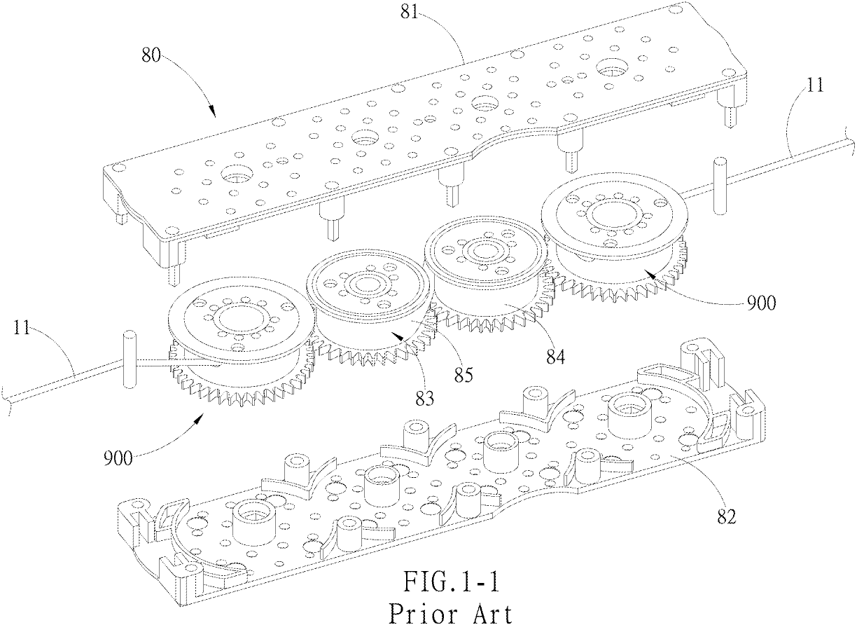

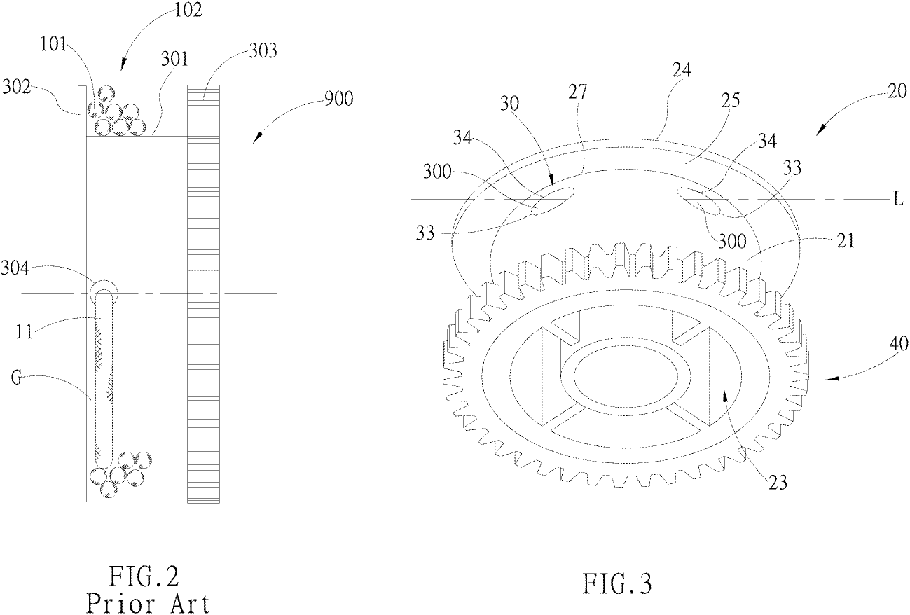

### DETAILED DESCRIPTION OF THE PREFERRED EMBODIMENTS

A leading wire of release wheel of pull cord in a window blind provides for the release wheel to define the winding angle of pull cord in the beginning of winding the pull cord, allowing the wound reel to be neatly ordered. On the release wheel, an intersection between a winding hub and an inner spoke side is opened with a piercing hole along an inscribed tangent, so that an outlet cord at the piercing hole can be close to the inner spoke side. In addition, along a direction in which the cord is wound out on the inner spoke side, a winding definer is further disposed, so that the direction of an initial reeling coil of winding can be defined in advance, thereby making the reel to be neatly ordered. A release wheel is disposed, having a winding hub with a hollow part. Two ends of the winding hub are combined respectively with a spoke, forming a wheel body. Following the angle of an inscribed tangent on the winding hub, a piercing hole is opened to connect the front wheel surface and the rear wheel surface of the winding hub, allowing the initial reeling coil of winding to be close to the inner spoke side.

An intersected ring edge on the circumference at a corner between the winding hub and the inner spoke side is provided with a winding definer to define the wiring angle of the initial reeling coil after winding by one turn.

Furthermore, the winding definer is disposed on the intersected ring edge at the intersection between the winding hub and the inner spoke side, wherein corresponding to the direction at which the cord exits from the piercing hole, a helicoid dike with a helicoid slope is disposed oppositely. A tip of the helicoid slope is close to the inner spoke side, and a surface of the helicoid slope is a helical plane.

The maximum cross section of the winding definer is equal to or smaller than the line width of the pull cord to be used.

By the abovementioned basic structures, the initial reeling coil of the winding of the pull cord can be defined linearly at the wiring direction, and the subsequent reel can be wound orderly following the precession direction of the initial reeling coil.

The construction of the present invention and the features provided by the present invention are described by referring to following drawings.

First of all, as shown in FIG. 3, a release wheel 20 is disposed inside a spring motor set of window blind, providing a wheel body for releasing a pull cord. The release wheel 20 is provided with a winding hub 21, an interior of the winding hub 21 is a hollow part 23, at least an end of the winding hub 21 is combined with a spoke 24, and a periphery of the spoke 24 is a linking structure 40. On a circumference of the winding hub 21, along an inscribed tangent L which is in tangent and parallel with a horizontal axis, a piercing hole 30, having a front and rear opening, is opened. In addition, an annular edge on the intersection between the winding hub 21 and the spoke 24 is an intersected ring edge 27.

A curved notch 33 is disposed in the direction of an exited cord at the piercing hole 30, and an inner edge line 34 on a side is close to the inner spoke side 25 of the spoke 24.

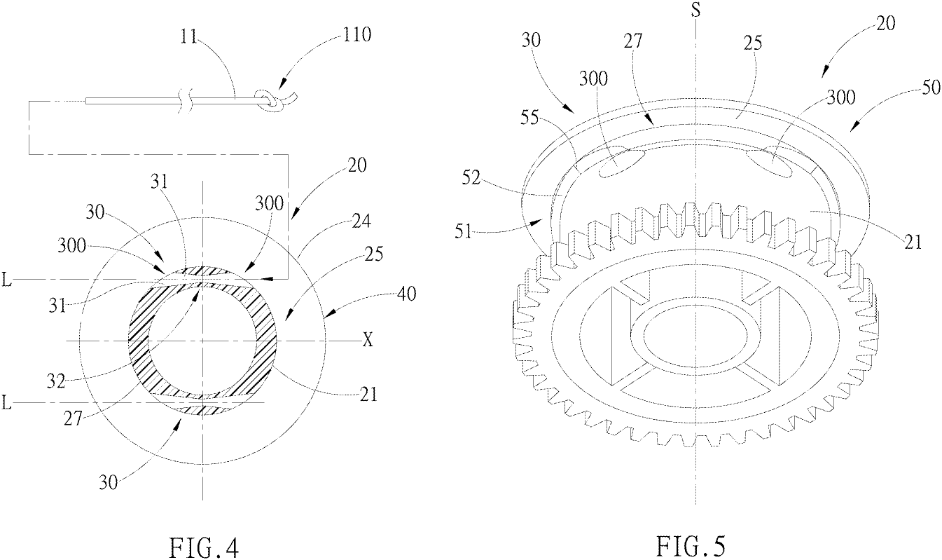

Referring to FIG. 4, at least an end of the winding hub 21 of the release wheel 20 is a spoke 24, and an inner surface of the spoke 24 is an inner spoke side 25; whereas, on the winding hub 21, along an inscribed tangent L, a piercing hole 30 is opened in an inscribed manner. The front and rear of the piercing hole 30 are penetrated with two openings 300.

The provided piercing hole 30 is connected in an inscribed manner on the plane of the winding hub 21 along the inscribed tangent L, and a middle in the passage is opened with a pass 32. Afront and rear part of the piercing hole 30 can be formed by two conical holes 31 which are connected back-to-back with each other coaxially, and as the middle is contracted inward due to the shape of hole, the pass 32 is formed.

Two sets of the piercing hole 30, passing through a latitude X, are parallel and symmetric to each other.

The piercing hole 30 provides for transfixing the pull cord 11 and fixing a thread end. First, a tail end of the pull cord 11 passes through the piercing hole 30 from one opening 300, and then the end that passes through the piercing hole 30 is tied up with a knot 110. After pulling back the pull cord 11, the knot 110 will be stopped unidirectionally as its diameter is larger than the pass 32, which allows the pull cord 11 to be combined rapidly with the release wheel 20.

Referring to FIG. 5, the release wheel 20 is provided with the piercing hole 30 on the intersected ring edge 27 between the winding hub 21 and the inner spoke side 25. A winding definer 50 surrounds annularly the intersected ring edge 27 of two openings 300 of the piercing hole 30, and is provided with a helicoid dike 51 corresponding to the direction at which the cord is spinning out of the openings 300 from the piercing hole 30. An axial surface of the helicoid dike 51 is provided with a helicoid slope 52 which rises up helically. A wedge tip portion 55 of the helicoid slope 52 is close to the inner spoke side 25, and the surface of helicoid slope 52 can be tilted outward on one side, or can be parallel to a corresponding radial line of a centerline S of the wheel body, such as a precession angle of square thread.

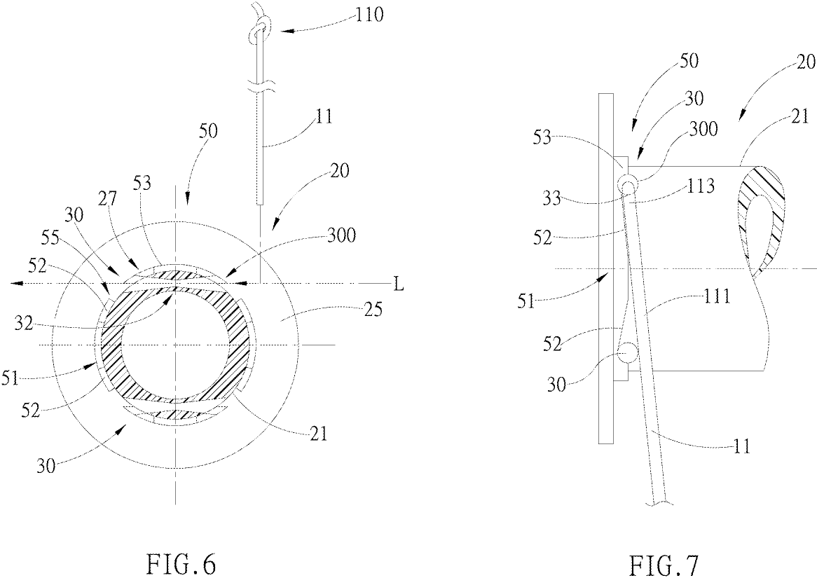

Referring to FIG. 6, the winding hub 21 provided by the release wheel 20 is transfixed linearly with the piercing hole 30 against an inscribed tangent L, a center of the piercing hole 30 is a pass 32 which provides for fastening and combining a knot 110 that is tied up at one end of the pull cord 11.

There can be two symmetric piercing holes 30, providing for two pull cords 11 to be combined in a different outlet direction. However, in an ordinary condition, only a single pull cord 11 is wound.

The intersected ring edge 27 of the winding hub 21 is annularly combined with the winding definer 50 which is integrally formed with the release wheel 20. In principle, the height of the winding definer 50, after subtracting the diameter of the winding hub 21 from the outer diameter of the winding definer 50, is close to or smaller than the line width of the pull cord 11. A segment on the two openings 300 of the winding definer 50 is an opposing section 53, and corresponding to the exit direction of the openings 300, the helicoid dike 51 with the helicoid slope 52 is disposed oppositely. A root part of the helicoid slope 52 is the wedge tip portion 55 which is disposed close to the inner spoke side 25.

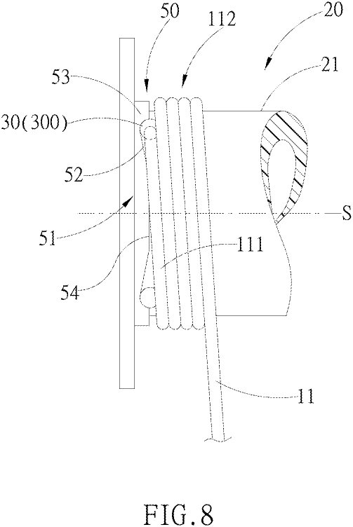

Referring to FIG. 7 and FIG. 8, the release wheel 20 provides for transfixing and winding to the pull cord 11. The pull cord 11 crosses over the curved notch 33 from a thread end 113 at an outlet of one opening 300 of the piercing hole 30. An initial reeling coil 111 is wound to the axial helicoid slope 52 of the helicoid dike 51 provided by the winding definer 50 and is then defined by the helicoid slope 52, forming a winding angle. When the initial reeling coil 111 is wound to a back end of the opening 300, it can be also defined by the exclusion of the opposing section 53. After that, the coil will be adjusted that it can be overlapped on a side (right side) next to the initial reeling coil 111 more accurately. Therefore, the formed reel 112 can be defined effectively and the winding can be neatly ordered.

For the subsequently wound reel 112 described above, a first turn will be squeezed leftward to a right side of the initial reeling coil 111, and then the winding angle of the initial reeling coil 111 can be squeezed leftward. Thus, there is a lot of chance that the segment corresponding to an axial dike 54 can be attached onto the axial dike 54 of the helicoid dike 51. The order of subsequent reel 112 is the same as the abovementioned condition, and in principle, each turn of the wound reel 112 can be wound in a same direction, thereby achieving an orderly winding.

The cross section of the helicoid dike 51 and the opposing section 53 is equal to or smaller than the cross section of the pull cord 11. The helicoid slope 52 rises up helically, and the surface is a helical plane.

In the present invention, the piercing hole is transfixed at a location between the winding hub and the inner spoke side along an inscribed tangent or radially. A periphery on a side of the hole body is close to the inner spoke side; hence, the initial reeling coil of the pull cord can be close to the inner spoke side, and the reel can be wound orderly by the definition of the winding definer, after winding sequentially. Therefore, in the process that the release wheel rotates to collect the pull cord, it can prevent from causing a difference in the collection speed of the pull cord due to entanglement and jump, which allows the operation to be run smoothly.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A leading wire of release wheel of pull cord in a window blind, providing for the release wheel to define a winding angle to the pull cord to wind a reel in order, in the beginning of winding the pull cord, comprising:
a release wheel, which is provided with a winding hub, with two ends of the release wheel being combined with a spoke, and an intersected ring edge being disposed on a vertical intersection between the winding hub and an inner spoke side of the spoke;
a piercing hole, which penetrates a front and rear of outer circumference of the winding hub along an inscribed tangent, with the piercing hole being opened at the intersected ring edge;
an annular winding definer, which is coaxially combined at the intersected ring edge, with a half of the rim of an opening provided by the piercing hole being intersected with the body of intersected ring edge, a helicoid dike with a helicoid slope being disposed in the direction of an outlet cord on the winding definer relative to the opening, and a provided wedge tip portion being cut at an inner edge of the opening and close to an angular position of a curved notch of the piercing hole.

2. The leading wire of release wheel of pull cord in a window blind, according to claim 1, wherein the piercing hole is formed by two conical holes which are connected back-to-back coaxially against an inscribed tangent, with a pass being disposed at a center of the connected inner hole.

3. The leading wire of release wheel of pull cord in a window blind, according to claim 1, wherein a radial height of the winding definer is equal to or smaller than a thread diameter of the provided pull cord.

4. The leading wire of release wheel of pull cord in a window blind, according to claim 1, wherein an axial width of the winding definer is equal to or smaller than a thread diameter of the provided pull cord.

5. The leading wire of release wheel of pull cord in a window blind, according to claim 1, wherein two piercing holes are provided, parallel disposed on an inscribed tangent at each side of the intersected ring edge which passes through a center of end surface.

6. The leading wire of release wheel of pull cord in a window blind, according to claim 1, wherein the winding definer and the release wheel are formed integrally.
